(19) United States
(12) Patent Application Publication
(10) Pub. No.: US 2026/0326268 A1
(43) Pub. Date: Oct. 22, 2026

(54) RATCHET MECHANISM AND WRENCH

(71) Applicant: HANGZHOU GREAT STAR INDUSTRIAL CO., LTD., Hangzhou City (CN)

(72) Inventor: Yueming LI, Hangzhou City (CN)

(21) Appl. No.: 19/667,886

(22) Filed: May 5, 2026

Related U.S. Application Data
(63) Continuation-in-part of application No. PCT/CN2025/143901, filed on Dec. 19, 2025.

(30) Foreign Application Priority Data
Apr. 21, 2025 (CN) 202510502398.7

(51) Int. Cl. B25B 13/46

(52) U.S. Cl. CPC B25B 13/465

(57) ABSTRACT

A ratchet mechanism, including: a first member having an annular surface, the annular surface being provided a plurality of teeth parallel to an axial direction thereof; a second member rotatably disposed within the annular surface of the first member; at least two pawl teeth, the at least two pawl teeth being disposed on at least one drive transmission member, the drive transmission member being movably disposed on the second member, the pawl teeth being configured to be capable of being in meshing engagement with the teeth to transmit motion between the first member and the second member, wherein the pawl teeth and the teeth have at least two different meshing engagement states.

### RELATED APPLICATIONS

This application is a continuation-in-part (CIP) application claiming benefit of PCT/CN2025/143901 filed on Dec. 19, 2025, which claims priority to Chinese Patent Application No. 202510502398.7 filed on Apr. 21, 2025, the disclosures of which are incorporated herein in their entirety by reference.

### BACKGROUND

The present invention relates to the technical field of hand tools, and in particular, to a ratchet mechanism and a wrench.

### Description of the Prior Art

When conventional hand tools such as screwdrivers and torque wrenches are in use, the hand's movement in the rotational direction is limited and cannot proceed continuously in one direction. Therefore, it is necessary to rotate the hand in the opposite direction or detach the hand tool from the screw being rotated, adjust the position, and then resume rotation. In some confined spaces, due to limited operating space, it is also often necessary to continuously adjust the position of the hand or the tool.

The advent of ratchet wrenches and ratchet screwdrivers enables the hand to bring the operating handle of the tool back during rotation, effectively overcoming the above problems. In existing ratchet wrenches or ratchet screwdrivers, when torque is transmitted via the ratchet and pawl, the torque applied to the handle is transmitted through the ratchet-pawl transmission mechanism to the output end. When the handle returns, the ratchet-pawl transmission mechanism idles, and each time it passes over one tooth, the pawl slides over the ratchet, producing a “click” sound. Consequently, during the process of applying the force through the handle and resetting, there is always a tooth gap. That is, after the handle reaches its limit position under the applied force, continued force application is only possible when the handle is rotated back by no less than the central angle corresponding to one tooth. For example, if 60 teeth are evenly distributed on the circumference of the ratchet, the central angle corresponding to one tooth is 6°. Therefore, after the handle reaches its limit position under applied force, continued force application is only possible when the handle is rotated back by 6°. Similarly, if 72 teeth are evenly distributed, the central angle corresponding to one tooth is 5°, requiring a 5° return rotation of the handle to resume force application. To reduce the angle of the handle's return rotation, increasing the number of teeth is one approach. However, while ensuring tooth profile size and product strength, increasing the number of teeth inevitably increases the overall size of the ratchet. If the number of teeth is increased while maintaining the same overall size of the ratchet, the teeth become smaller, reducing the reliability of meshing engagement between the pawl and the teeth and diminishing the torque transmission capability. Furthermore, when the number of teeth is relatively small, the return resistance is higher, which can easily lead to ratchet failure and increased play. Therefore, for a given outer diameter, to ensure product strength, the number of teeth on the ratchet cannot be increased indefinitely. Yet, a small tooth number results in a larger return angle, limiting usability in confined spaces.

Accordingly, those skilled in the art are dedicated to providing a ratchet mechanism and a wrench using the ratchet mechanism, which can ensure product strength under a given outer diameter, reduce return resistance, minimize play, better eliminate the effect of tooth clearance, and improve transmission efficiency.

### SUMMARY

To achieve the above objectives, the present invention provides a ratchet mechanism. The ratchet mechanism includes:
a first member having an annular surface, the annular surface being provided a plurality of teeth parallel to an axial direction thereof;
a second member rotatably disposed within the annular surface of the first member;
at least two pawl teeth, the at least two pawl teeth being disposed on at least one drive transmission member, the drive transmission member being movably disposed on the second member, the pawl teeth being configured to be capable of being in meshing engagement with the teeth to transmit motion between the first member and the second member, where the pawl teeth and the teeth have at least two different meshing engagement states.

Further, the ratchet mechanism includes a plurality of drive transmission members, and each of the plurality of drive transmission members has at least one of the pawl teeth.

Further, each of the plurality of drive transmission members has at least two of the pawl teeth, where the meshing engagement states between the pawl teeth of each of the drive transmission members and the teeth have at least two types.

Further, the pawl teeth of each of the drive transmission members are distributed sequentially along a sliding direction of the drive transmission member at which the pawl teeth are located, and a distance between a tooth crest of each pawl tooth and a tooth groove decreases sequentially, so that a contact area between the pawl teeth and the teeth decreases sequentially.

Further, at least one accommodation cavity is disposed along a circumferential direction of the second member, one said drive transmission member is disposed within one said accommodation cavity, and the drive transmission member is configured to be slidable along the accommodation cavity, so that the pawl teeth extend out of an opening of the accommodation cavity.

Further, each said drive transmission member is provided with a relief portion, and the relief portion is located on a side surface of the drive transmission member opposite to the pawl teeth.

Further, a side of the accommodation cavity is provided with a first guide groove extending along a sliding direction of the drive transmission member, the drive transmission member has a first guide block cooperating with the first guide groove, and the first guide block is located within the first guide groove.

Further, the ratchet mechanism includes a cover, and the cover is fitted over an end face of the second member on which the accommodation cavity is provided.

Further, the cover is provided with a positioning groove, and the second member is provided with a protrusion cooperating with the positioning groove.

Further, the cover includes a second guide groove extending along a sliding direction of the drive transmission member, the drive transmission member is provided with a second guide block cooperating with the second guide groove, and the second guide block is located within the second guide groove.

Further, a width of the drive transmission member is equal to or greater than a dimension of the teeth along an axial direction of the first member.

Further, the ratchet mechanism includes at least two groups of drive transmission mechanisms, each group of drive transmission mechanisms includes at least two drive transmission members, and meshing engagement states between the at least two drive transmission members and the teeth are same.

Further, each group of the drive transmission mechanisms is symmetrically distributed along a circumferential direction of the second member.

Further, the second member is provided with a drive portion, and the drive portion is configured to cooperate with an external element to transmit a torque to the external element.

Further, an elastic member is disposed between the drive transmission member and the second member, the elastic member is configured to apply a force onto the drive transmission member, and the force urges the drive transmission member to move toward the teeth.

Further, the elastic member is a spring, an end of the spring is sleeved over a boss of the drive transmission member, and another end of the spring is connected to a side wall of the accommodation cavity.

Further, the side wall of the accommodation cavity is provided with a channel for receiving the spring.

Further, the ratchet mechanism includes a plurality of drive transmission members, the second member includes a plurality of accommodation cavities, one of the drive transmission members is disposed within one of the accommodation cavities, each of the drive transmission members is provided with a plurality of pawl teeth, and an area between each of the pawl teeth and the teeth are different.

The present application further provides a wrench. The wrench includes a handle, and an end of the handle is provided with the ratchet mechanism described above.

Further, the first member of the ratchet mechanism is integrally formed with the handle.

The ratchet mechanism provided in the present application utilizes different meshing engagement states between the ratchet and the drive transmission member. Without increasing the number of teeth, this design adds transmission stages, thereby enhancing transmission efficiency. The precise meshing engagement provides reduced play and better eliminates the effect of tooth clearance. During return motion, the increased number of stages allows for a smaller return angle while maintaining strength, making it suitable for more confined installation spaces. Additionally, it reduces resistance during the return rotation between the ratchet and the pawl, effectively minimizing wear.

The concept, specific structure, and technical effects of the present invention will be further described below with reference to the accompanying drawings, so as to fully understand the objectives, features, and effects of the present invention.

### BRIEF DESCRIPTION OF THE DRAWINGS

FIG. 1 is a schematic exploded view of a ratchet mechanism according to Embodiment 1.

FIG. 2 is a schematic fully-exploded view of a ratchet mechanism according to Embodiment 1.

FIG. 3 is a top view of a ratchet mechanism according to Embodiment 1.

FIG. 4 is a side view of a ratchet mechanism according to Embodiment 1.

FIG. 5 is a cross-sectional view of a cross section A-A in FIG. 4.

FIG. 6 is a schematic enlarged view of an area B in FIG. 5.

FIG. 7 is a schematic enlarged view of an area C in FIG. 5.

FIG. 8 is a schematic enlarged view of an area D in FIG. 5.

FIG. 9 is a schematic structural view of a second member of a ratchet mechanism in Embodiment 1 after being assembled with a cover and a drive transmission member.

FIG. 10 is a schematic exploded view of FIG. 9;

FIG. 11 is a schematic structural view of a second member.

FIG. 12 is a top view of a second member.

FIG. 13 is a schematic view of a second member after being assembled with a drive transmission member.

FIG. 14 is a schematic structural view of a cover.

FIG. 15 is a schematic structural view of a drive transmission member.

FIG. 16 is a front view of FIG. 15.

FIG. 17 is a schematic view of FIG. 15 from another perspective.

FIG. 18 is a schematic view of a meshing engagement state between a drive transmission member and teeth in Embodiment 2.

FIG. 19 is a schematic enlarged view of an area E in FIG. 18.

FIG. 20 is a schematic enlarged view of an area F in FIG. 18.

FIG. 21 is a schematic enlarged view of an area G in FIG. 18.

FIG. 22 is a schematic structural view of a wrench.

FIG. 23 is a schematic exploded view of a wrench.

Description of reference signs: 100—ratchet mechanism,
110—first member, 111—first through hole, 112—tooth,
120—second member, 121—second through hole, 122—drive portion, 123—accommodation cavity, 124—opening, 125—first guide groove, 126—protrusion, 127—first boss, 128—first end face,
130—drive transmission member, 130a—first drive transmission member, 130b—second drive transmission member, 130c—third drive transmission member, 130d—fourth drive transmission member, 130e—fifth drive transmission member, 130f—sixth drive transmission member, 131—pawl tooth, 132—relief portion, 133—first guide block, 134—second guide block, 135—boss, 136—elastic member,
140—cover, 141—positioning groove, 142—second boss, 143—second guide groove,
200—wrench, 210—handle, 220—wrench head, 230—fixed wrench portion, 231—third through hole.

### DETAILED DESCRIPTION

Multiple preferred embodiments of the present invention will be introduced below with reference to the accompanying drawings, so as to make its technical content clearer and easier to understand. The present invention may be embodied in various different forms and the present invention should not be construed as being limited to the embodiments set forth herein.

In the description, elements with identical structure are marked with the same reference numerals, and like elements with similar structure or function are marked throughout with like reference numerals, respectively. The dimension and thickness of each element in the accompanying drawings are arbitrarily shown, and the present invention does not define the dimension and thickness of each element. Certain parts may be shown somewhat exaggerated in thickness in the interest of clarity.

It should be noted that when a component is referred to as being “fixed to” or “disposed on” another component, it may be directly on the other component, or intervening components may be present. When a component is considered to be “connected” to another component, it may be directly connected to the other component, or there may be intervening components at the same time. The terms “vertical”, “horizontal”, “upper”, “lower”, “left”, “right” and similar expressions used in the description of the present application are for descriptive purposes only and do not denote the only implementations. Furthermore, the terms “first”, “second”, and the like are used for descriptive purposes only and are not to be construed as indicating or implying relative importance or implicitly specifying the quantity of the indicated technical features. Therefore, features defined with “first”, “second” may explicitly or implicitly include at least one such feature. In the description of the present application, the meaning of “a plurality” is at least two, for example two, three, etc., unless otherwise explicitly and specifically defined. In the present application, unless otherwise explicitly specified and limited, a first feature being “on” or “under” a second feature may mean that the first feature is in direct contact with the second feature, or that the first feature and the second feature are in indirect contact through an intermediate medium. Moreover, a first feature being “above”, “over” or “on” a second feature may mean that the first feature is directly above or obliquely above the second feature, or merely indicates that the horizontal height of the first feature is higher than that of the second feature. A first feature being “below”, “underneath” or “under” a second feature may mean that the first feature is directly below or obliquely below the second feature, or merely indicates that the horizontal height of the first feature is lower than that of the second feature. Unless otherwise defined, all technical and scientific terms used in the description of the present application have the same meanings as commonly understood by one of ordinary skill in the technical field to which the present application belongs. The terms used in the description of the present application are for the purpose of describing specific implementations only and are not intended to limit the present application. The term “and/or” used in the description of the present application includes any and all combinations of one or more of the associated listed items.

### I. Ratchet Mechanism

The present application provides a ratchet mechanism, including a first member, a second member, and a drive transmission member, where the first member is an annular member provided with teeth over its entire circumferential surface, the teeth may be disposed on an outer circumferential surface or inner circumferential surface of the first member; the second member is capable of rotating relative to the first member in a circumferential direction, the second member is configured to carry the drive transmission member, and the drive transmission member is provided with at least two pawl teeth capable of being in meshing engagement with the teeth of the annular member. The drive transmission member is capable of transmitting unidirectional motion. Specifically, when an external force acts on the first member, causing the first member to rotate in a first direction, the first member is in meshing engagement with the drive transmission member, thereby transmitting motion to the second member and causing the second member to rotate in a predetermined direction. The first direction may be a clockwise direction or counterclockwise direction. It should be understood that the second member may also be configured as a driving member. That is, an external force may be applied to the second member to cause the second member to move in the first direction, and then the motion is transmitted to the first member through the drive transmission member, thereby causing the first member to rotate in the predetermined direction. During the motion transmission process, the drive transmission member has different meshing engagement states with the teeth on the first member. These meshing engagement states include at least two types: a first meshing engagement state, i.e., a full meshing engagement state, refers to the pawl teeth of the drive transmission member being in full meshing engagement with the teeth on the first member; a second meshing engagement state, i.e., a partial meshing engagement state, refers to the pawl teeth of the drive transmission member being in partial meshing engagement with the teeth on the first member. When transmitting motion, the meshing engagement state of the pawl teeth of the drive transmission member varies periodically with the rotation of the ratchet mechanism. It should be noted that the pawl teeth of the drive transmission member and the teeth of the first member may have different meshing engagement states in various forms: (1) there are a plurality of drive transmission members, and all the pawl teeth on one drive transmission member have the same meshing engagement state with the teeth of the first member, while each drive transmission member is in a different meshing engagement state with the first member, thereby achieving a plurality of meshing engagement states; for example, the pawl teeth on the first drive transmission member are in a full meshing engagement state with the teeth of the first member, while the pawl teeth on the second drive transmission member are in a partial meshing engagement state with the teeth of the first member, where the partial meshing engagement state further includes a plurality of meshing engagement states with different contact areas; (2) the drive transmission member is provided with at least two pawl teeth, and each pawl tooth has a different meshing engagement state with the teeth of the first member; for example, the first pawl tooth on the drive transmission member is in a full meshing engagement state with the teeth of the first member, while the second pawl tooth is in a partial meshing engagement state with the teeth of the first member; for another example, the first pawl tooth is in half meshing engagement with the teeth of the first member, and the second pawl tooth is in one-third meshing engagement with the teeth of the first member, that is, even in a partial meshing engagement state, the pawl teeth may still have meshing engagement states with different contact areas; (3) the meshing engagement state of the pawl teeth of each drive transmission member with the teeth of the first member is different from that of other drive transmission members, while at the same time, different pawl teeth on the same drive transmission member also have different meshing engagement states with the teeth of the first member.

The present application will describe the ratchet mechanism in detail through a plurality of embodiments.

### Embodiment 1

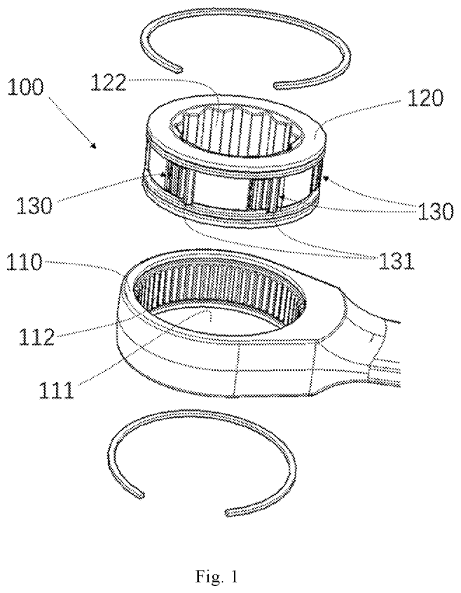

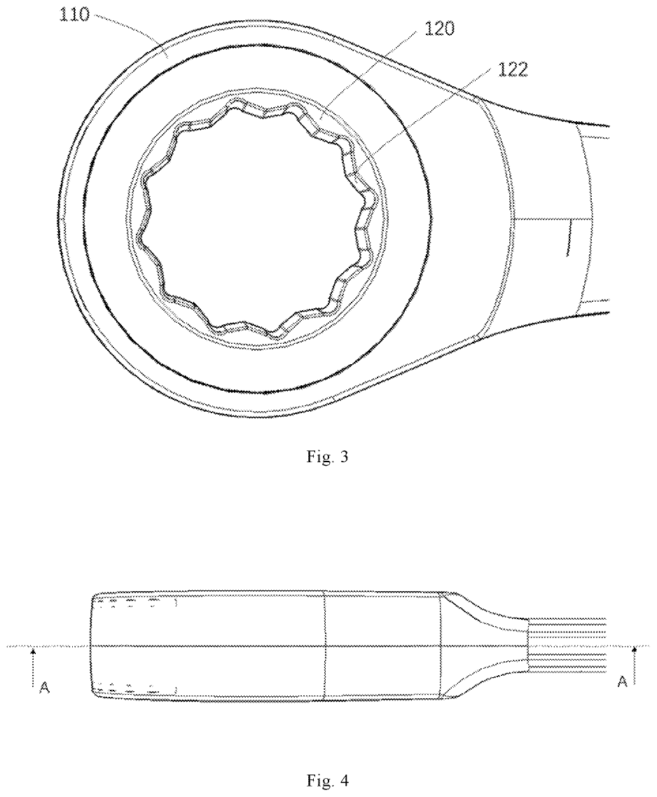

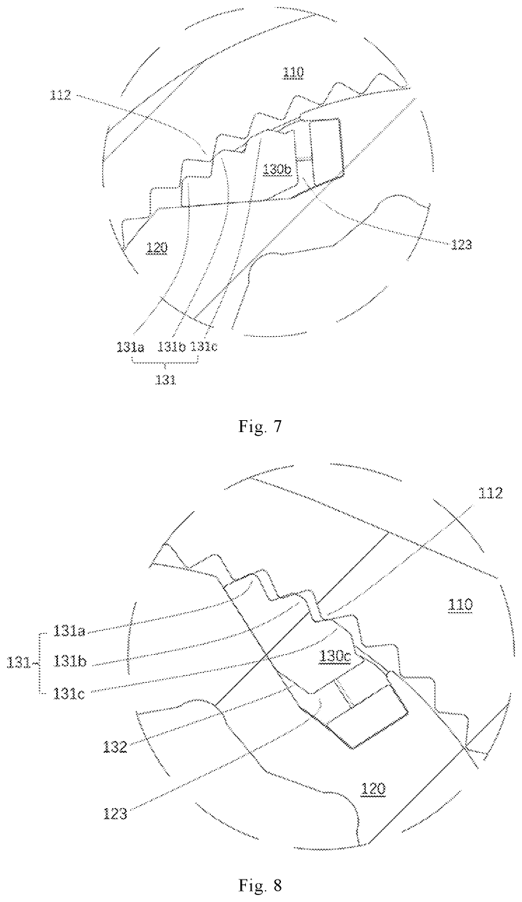

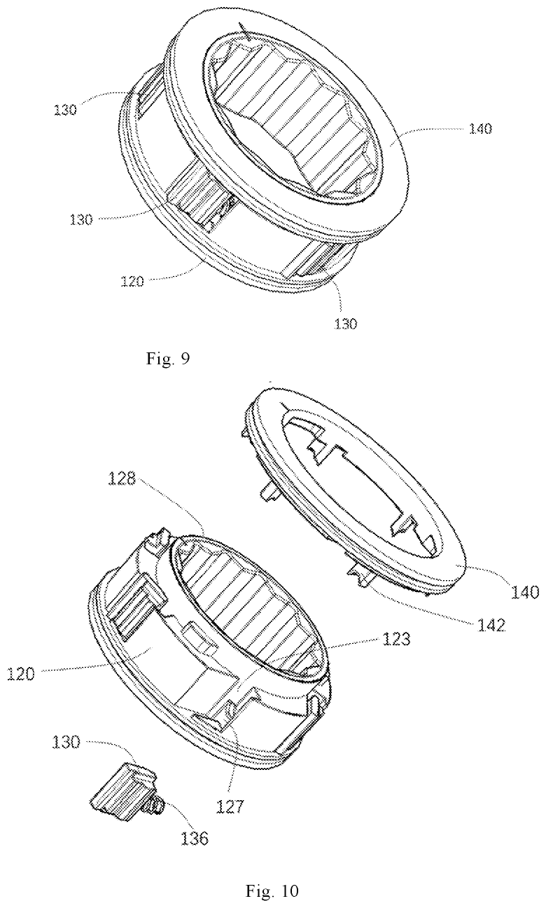

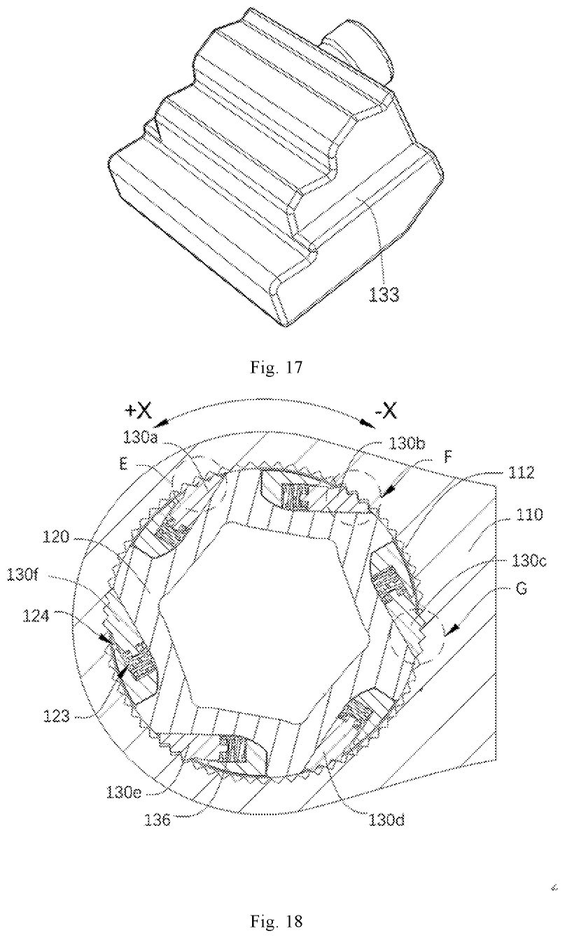

FIG. 1 to FIG. 17 show Embodiment 1.

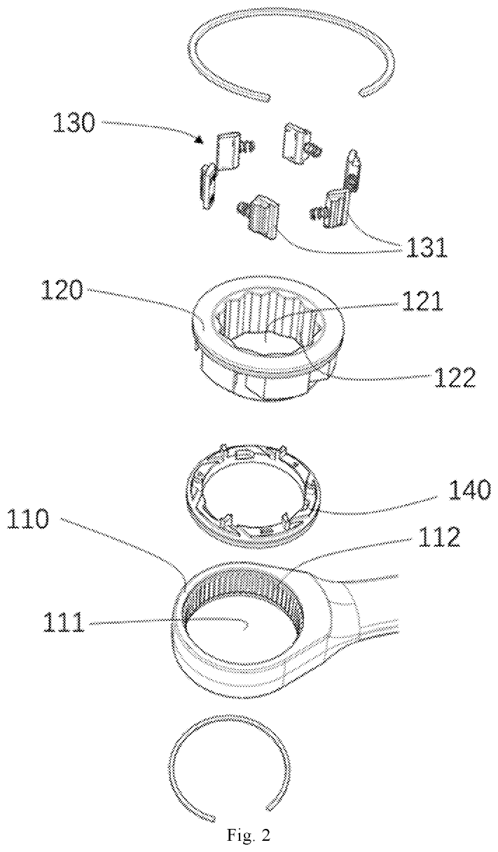

As shown in FIG. 1 and FIG. 2, the ratchet mechanism 100 of this embodiment includes a first member 110, a second member 120, and a plurality of drive transmission members 130. The first member 110 and the second member 120 are arranged coaxially and are relatively rotatable with respect to each other. The first member 110 is provided with a first through hole 111 extending axially. A side wall of the first through hole 111 is provided with a plurality of teeth 112. The teeth 112 extend along the axial direction of the first member 110 and are parallel to an axial direction of the first member 110. The second member 120 is disposed within the first through hole 111. The drive transmission members 130 are movably disposed on the second member 120. The drive transmission members 130 are provided with pawl teeth 131. The pawl teeth 131 may be in meshing engagement with the teeth 112 of the first member 110 to transmit unidirectional motion between the first member 110 and the second member 120. The second member 120 is provided with a second through hole 121 extending axially. A side wall of the second through hole 121 is provided with a drive portion 122 that cooperates with nuts, screws, and the like. The drive portion 122 may be hexagonal or wave-shaped and may be fitted over external components such as nuts or screws. When the second member 120 rotates, it can drive the nuts, screws, or the like to rotate through the cooperation of the drive portion 122 with the nuts, screws, or the like. It should be understood that the drive portion 122 may also be configured as a drive shaft or a screwdriver bit. The drive shaft may be a solid shaft or a non-solid shaft. The drive shaft is capable of being inserted into external components such as screws or sockets, and the non-solid shaft is capable of accommodating other components therein.

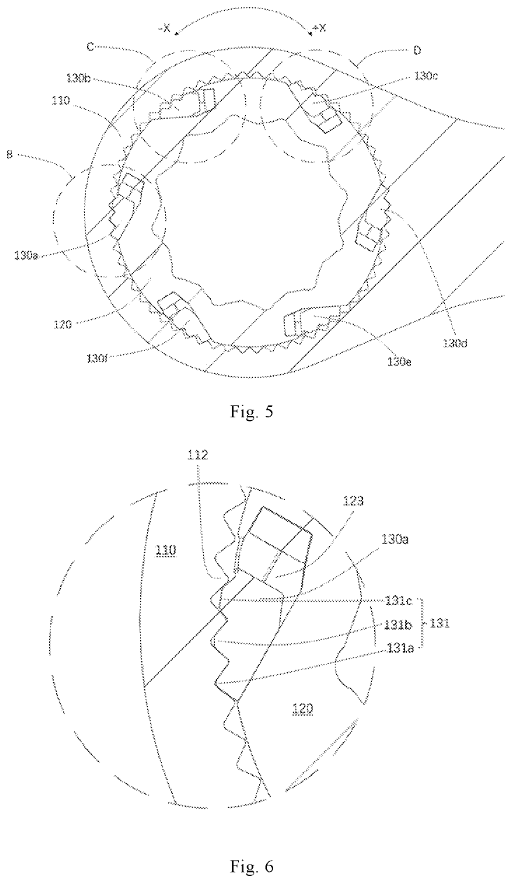

The drive transmission member 130 transmits unidirectional motion between the first member 110 and the second member 120. The direction may be-X direction as shown in FIG. 5, or +X direction, and may be set according to actual requirements. In this embodiment, it is assumed that the drive transmission member 130 transmits unidirectional motion along the −X direction between the first member 110 and the second member 120, that is, the second member 120, the teeth of the first member 110, and the drive transmission member 130 undergo no relative motion.

The meshing engagement states between the pawl teeth 131 of the drive transmission member 130 and the teeth 112 of the first member 110 are as shown in FIG. 5 to FIG. 8. These pawl teeth 131 and the teeth 112 of the first member 110 have at least two different meshing engagement states: one is that the pawl teeth 131 are in full meshing engagement with the teeth 112, and another is that the pawl teeth 131 are in partial meshing engagement with the teeth 112. In the partial meshing engagement state, the contact area between the pawl teeth 131 and the teeth 112 may be further varied, for example, one-third meshing engagement, half meshing engagement, and so on. In existing hand tools utilizing the ratchet mechanism 100, when the handle is rotated in a reverse direction, it must be turned by at least the angle corresponding to one tooth groove of the pawl teeth. However, when the operating space is too confined to allow rotation by such an angle, the hand tool becomes unusable, thereby limiting its application range. The ratchet mechanism 100 provided in the present application, when applied in a hand tool, features at least two pawl teeth 131 having different meshing engagement states with the teeth 112 of the first member 110. Consequently, when the first member 110 rotates in the +X direction as shown in FIG. 5, it only needs to rotate by an angle smaller than that of one tooth groove of the teeth 112 to subsequently rotate again in the −X direction as shown in the figure, thereby tightening or loosening components such as sockets, nuts, and bolts. This achieves a multi-tooth effect and enables the use of the hand tool within confined operating spaces. Moreover, compared to existing technologies in which the number of teeth is increased by enlarging the ratchet volume, the number of teeth is increased by reducing tooth size, or two pawls with lateral angular offsets are provided in parallel along the axial direction of the ratchet, the ratchet mechanism 100 provided in the present invention does not require increasing the overall tooth volume or reducing the tooth size. Furthermore, the drive transmission members 130 are arranged along the circumferential direction of the second member 120. As a result, the width of each drive transmission member 130 can be equal to or slightly greater than the width of the teeth 112, i.e., the dimension along the axial direction of the teeth 112, thereby increasing the contact area between the pawl teeth and the teeth. Under a given outer diameter of the hand tool, this ensures the transmission strength between the pawl teeth 131 and the teeth 112, preventing tooth breakage due to insufficient torque between the pawl teeth 131 and the teeth 112, thereby guaranteeing the strength of the hand tool. The state in which the pawl teeth 131 are in full meshing engagement with the teeth 112 refers to a condition where the tooth crests of the pawl teeth 131 are opposite the bottoms of the tooth grooves of the teeth 112. The state in which the pawl teeth 131 are in partial meshing engagement with the teeth 112 refers to a condition where the tooth crests of the pawl teeth 131 are misaligned with the bottoms of the tooth grooves of the teeth 112, that is, the tooth crests of the pawl teeth 131 are opposite the sidewalls of the tooth grooves of the teeth 112, or the tooth crests of the pawl teeth 131 are opposite the tooth crests of the teeth 112. Under different meshing engagement states, the contact area between the sidewalls of the pawl teeth 131 and the sidewalls of the tooth grooves of the teeth 112 varies. In the full meshing engagement state, the sidewalls of the pawl teeth 131 substantially fully conform to the sidewalls of the tooth grooves of the teeth 112. In the partial meshing engagement state, the sidewalls of the pawl teeth 131 are only partially in contact with the sidewalls of the tooth grooves of the teeth 112, or there is no contact.

In some implementations, referring to FIG. 5, the ratchet mechanism 100 adopts six drive transmission members 130, namely, a first drive transmission member 130a, a second drive transmission member 130b, a third drive transmission member 130c, a fourth drive transmission member 130d, a fifth drive transmission member 130e, and a sixth drive transmission member 130f. These six drive transmission members 130 are uniformly spaced apart along the circumferential direction of the second member 120. The second member 120 is provided with accommodation cavities 123 for accommodating the drive transmission members 130. Each drive transmission member 130 is located within one accommodation cavity 123. The accommodation cavities 123 are uniformly distributed along the circumferential direction of the second member 120. An end of each accommodation cavity 123 is provided with an opening 124 facing the first member 110. The pawl teeth 131 of the drive transmission member 130 located within the accommodation cavity 123 extend out through the opening 124 to be in meshing engagement with the teeth 112 of the first member 110. The six drive transmission members 130 are divided into three groups, and the two drive transmission members 130 in each group have the same meshing engagement state with the teeth 112 of the first member 110, that is, the first drive transmission member 130a and the fourth drive transmission member 130d have the same meshing engagement state, the second drive transmission member 130b and the fifth drive transmission member 130e have the same meshing engagement state, and the third drive transmission member 130c and the sixth drive transmission member 130f have the same meshing engagement state. This ensures stability and reliability during meshing engagement between the drive transmission members 130 and the teeth, preventing accidental slippage between any one drive transmission member 130 and the teeth, which could lead to transmission failure. Preferably, the two drive transmission members 130 in each group are substantially symmetrically positioned on the second member 120. In other implementations, the six drive transmission members 130 may also all be in different meshing engagement states with the teeth 112. Alternatively, it may include 3, 4, 5, or more drive transmission members 130, which is not specifically limited here.

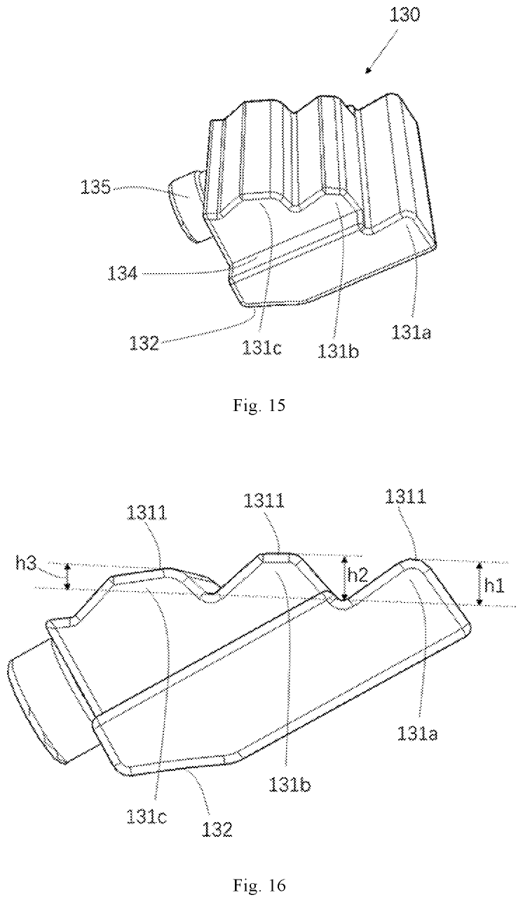

The structure of the drive transmission member 130 is as shown in FIG. 15 to FIG. 17. In some implementations, the drive transmission member 130 includes at least two pawl teeth 131, each pawl tooth 131 includes a tooth crest 1311, with a tooth groove between adjacent pawl teeth 131, and a distance between the tooth crest 1311 of each pawl tooth 131 and a bottom of the tooth groove is different, thereby causing different meshing engagement states between the different pawl teeth 131 of the same drive transmission member 130 and the teeth 112. Preferably, as shown, the three pawl teeth on the drive transmission member 130, namely a first pawl tooth 131a, a second pawl tooth 131b, and a third pawl tooth 131c, are distributed sequentially from one end of the drive transmission member 130 to the other end, and distances of the tooth crests 1311 decrease sequentially, that is, a distance h1 between a tooth crest 1311 of the first pawl tooth 131a and the tooth groove, a distance h2 between a tooth crest 1311 of the second pawl tooth 131b and the tooth groove, and a distance h3 between a tooth crest 1311 of the third pawl tooth 131c and the tooth groove decrease sequentially. Preferably, the tooth crests 1311 of the second pawl tooth 131b and the third pawl tooth 131c are configured as flat surfaces to reduce the distance between the tooth crest and the tooth groove. Referring to FIG. 6, taking the first drive transmission member 130a as an example, the first pawl tooth 131a is in full meshing engagement with the teeth 112, the contact area between the second pawl tooth 131b and the teeth 112 is smaller than that of the first pawl tooth 131a, and the contact area between the third pawl tooth 131c and the teeth 112 is smaller than that of the second pawl tooth 131b. That is, the contact areas between the first pawl tooth 131a, the second pawl tooth 131b, and the third pawl tooth 131c of the first drive transmission member 130a and the teeth 112 decrease sequentially. The other drive transmission members 130 are in the same situation as the first drive transmission member 130a, that is, the contact areas between the three pawl teeth 131 and the teeth 112 decrease sequentially.

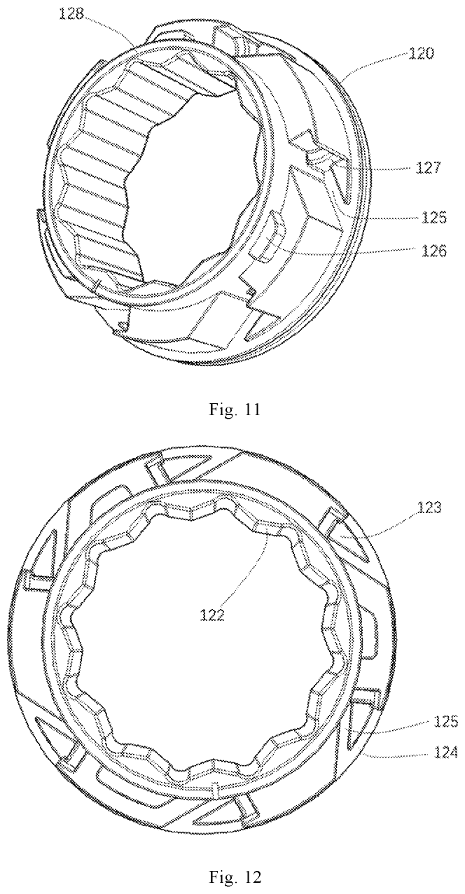

Referring to FIG. 10, FIG. 11, and FIG. 12, the second member 120 includes a first end face 128, the first end face 128 is provided a plurality of accommodation cavities 123 corresponding in number to the drive transmission members 130, the openings 124 of the accommodation cavities 123 face the teeth 112, and each drive transmission member 130 is slidably disposed within one accommodation cavity 123. The pawl teeth of the drive transmission member 130 are capable of extending out through the opening 124 of the accommodation cavity 123 to be in meshing engagement with the teeth 112. In the shown implementation, six accommodation cavities 123 are uniformly spaced apart along the axial direction on the first end face 128 of the second member 120. It should be understood that in other implementations, the number of accommodation cavities 123 may be set according to the number of drive transmission members 130, which is not specifically limited here.

Referring to FIG. 10 and FIG. 14, the ratchet mechanism 100 further includes a cover 140 fitted over the first end face 128 of the second member 120. The cover 140 is capable of preventing the drive transmission members 130 from disengaging from the accommodation cavities 123 along the axial direction of the second member 120. The cover 140 may be configured as an annular structure. The cover 140 and the second member 120 are provided with guide components to ensure that the cover 140 can be quickly positioned when the cover 140 is installed onto the second member 120, thereby facilitating the installation of the cover 140. Preferably, the guide components include a positioning groove 141 provided on the cover 140 and a protrusion 126 provided on the second member 120. When installing the cover 140, the protrusion 126 is aligned with the positioning groove 141 so that the projection 126 is inserted into the positioning groove 141, which can restrict the relative position between the cover 140 and the second member 120, thereby achieving quick positioning and installation of the cover 140. It should be understood that the guide components may also be other structures capable of quickly positioning the cover 140 and the second member 120, such as interlocking clips, which is not specifically limited here. The number of protrusions 126 and positioning grooves 141 may be set according to actual needs, and they are distributed along the circumferential direction of the second member 120 and arranged alternately with the accommodation cavities 123, so as not to interfere with the drive transmission members 130.

The width of the accommodation cavity 123 is the same as that of the drive transmission member 130, that is, the accommodation cavity 123 itself serves as a limiting groove to ensure that the drive transmission member 130 does not shake or shift when sliding within the accommodation cavity 123, guaranteeing that the drive transmission member 130 can accurately re-engage with the teeth each time after disengagement. The accommodation cavity 123 may be formed independently on the second member 120 or may be enclosed jointly with the cover 140. In some implementations, to enable the drive transmission member 130 to slide along a predetermined direction within the accommodation cavity 123, a first guide groove 125 is provided on one side of the accommodation cavity 123 (the side away from the cover 140), and a corresponding side of the drive transmission member 130 is provided with a first guide block 133. The first guide block 133 extends outward from the drive transmission member 130, and when the drive transmission member 130 is installed in the accommodation cavity 123, the first guide block 133 is located within the first guide groove 125. In some implementations, the cover 140 is provided with a second guide groove 143, and a side of the drive transmission member 130 opposite the first guide block 133 is provided with a second guide block 134. When the cover 140 is fitted over the second member 120, the second guide block 134 is located within the second guide groove 143. The first guide groove 125, the second guide groove 143, and the accommodation cavity 123 extend in the same direction. The sliding fit between the first guide block 133 and the first guide groove 125, as well as between the second guide block 134 and the second guide groove 143, provides sliding limitation and guidance for the drive transmission member 130, ensuring that the drive transmission member 130 always slides along the extending direction of the accommodation cavity 123. Simultaneously, it can further enhance the stability of the drive transmission member 130 during sliding, thereby reducing shaking. It should be understood that only one of the cover 140 and an inner wall of the accommodation cavity 123 may be provided with a guide groove, and a guide block may be provided on a corresponding side of the drive transmission member 130, as long as the sliding direction of the drive transmission member 130 can be restricted.

In some implementations, the drive transmission member 130 is provided with a relief portion 132, and the relief portion 132 is located on a side surface opposite to the pawl teeth 131. By providing the relief portion 132, interference can be avoided when the drive transmission member 130 slides along the accommodation cavity 123, thereby improving the smoothness of the sliding motion of the drive transmission member 130.

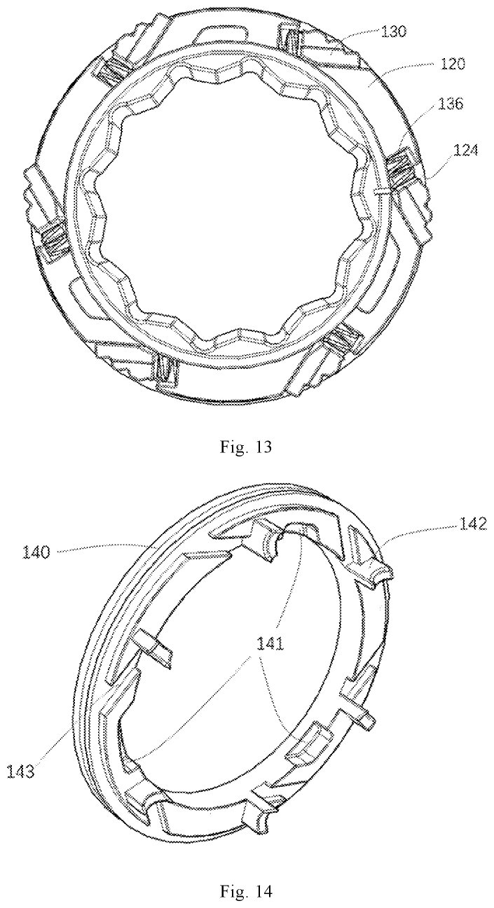

As shown in FIG. 13, the ratchet mechanism 100 further includes a plurality of elastic members 136 corresponding in number to the drive transmission members 130. The elastic members 136 are disposed between the drive transmission members 130 and the second member 120. The elastic members 136 are capable of applying an elastic force to the drive transmission members 130, thereby giving the drive transmission members 130 a tendency to move toward the side close to the teeth 112. The elastic members 136 are capable of applying a preload force toward the teeth 112 to the drive transmission members 130, causing the drive transmission members 130 to tend to move toward the side close to the teeth 112, thereby assisting the meshing engagement of the drive transmission members 130 with the teeth 112. Two end of each elastic member 136 abut against the drive transmission member 130 and the second member 120, respectively. Preferably, they abut against the drive transmission member 130 and the inner wall of the accommodation cavity 123, respectively. When the drive transmission member 130 disengages from the teeth 112, it moves within the accommodation cavity 123 toward the side away from the teeth 112, causing the elastic member 136 to be further compressed. The elastic members 136 may be elastic elements such as springs, rubber members, or silicone members. In the implementation shown in FIG. 13, the elastic members 136 are springs. An end of each spring abuts against the side wall of the accommodation cavity 123, while another end is sleeved over a boss 135 of the drive transmission member 130. In some implementations, a side wall of the accommodation cavity 123 in contact with the spring is provided with a channel for receiving the spring. In some implementations, referring to FIG. 11 and FIG. 14, a side wall of the accommodation cavity 123 is provided with a first boss 127, an end of the first boss 127 is configured as an arc shape, the cover 140 is provided with a second boss 142, and an end of the second boss 142 is configured as an arc shape. When the cover 140 is fitted over the second member 120, the two arc-shaped ends of the first boss 127 and the second boss 142 together enclose to form a channel for receiving the spring.

### Embodiment 2

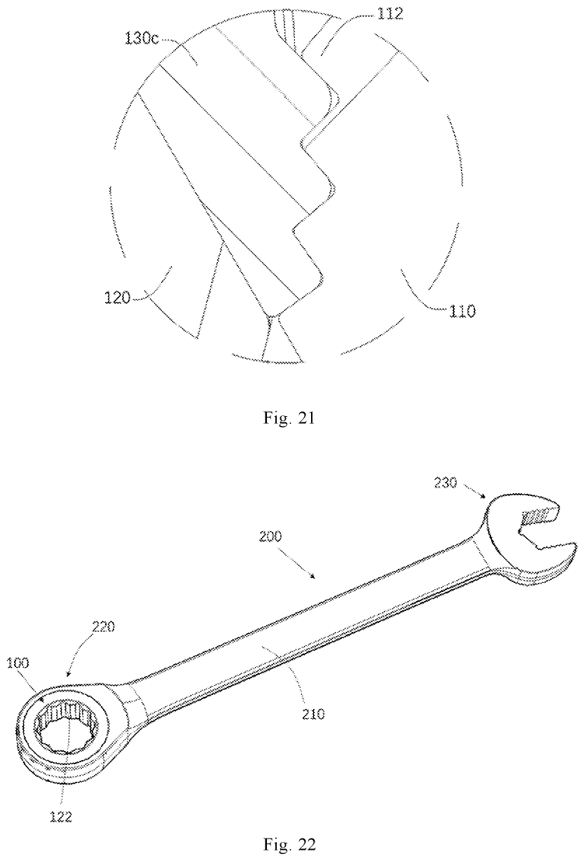

FIG. 18 to FIG. 21 show Embodiment 2. Most features of this embodiment are the same as those of Embodiment 1, and only the differences between the two embodiments will be described below.

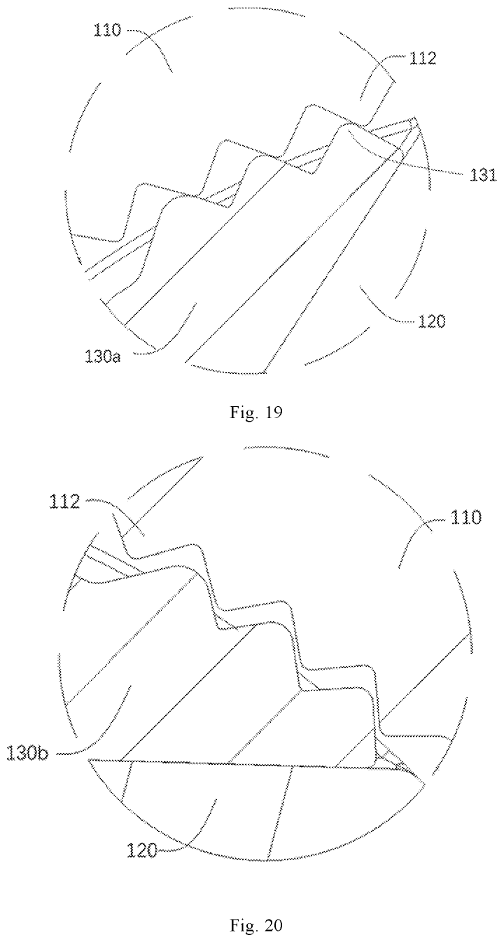

In this embodiment, the pawl teeth 131 of each drive transmission member 130 have the same meshing engagement state with the teeth 112, while different drive transmission members 130 have different meshing engagement states with the teeth 112. As shown in FIG. 18, the ratchet mechanism includes six drive transmission members, namely, a first drive transmission member 130a, a second drive transmission member 130b, a third drive transmission member 130c, a fourth drive transmission member 130d, a fifth drive transmission member 130f, and a sixth drive transmission member 130e. The six drive transmission members are uniformly spaced apart along the circumferential direction of the second member 120, and every two drive transmission members 130 have the same meshing engagement state with the teeth 112, that is, the first drive transmission member 130a and the fourth drive transmission member 130d have the same meshing engagement state, the second drive transmission member 130b and the fifth drive transmission member 130e have the same meshing engagement state, and the third drive transmission member 130c and the sixth drive transmission member 130f have the same meshing engagement state. In the state shown in FIG. 19 to FIG. 21, the first drive transmission member 130a and the fourth drive transmission member 130d are in a partial meshing engagement state with the teeth 112, for example, a one-third meshing engagement state; the second drive transmission member 130b and the fifth drive transmission member 130e are in a partial meshing engagement state with the teeth 112, for example, a two-thirds meshing engagement state; and the third drive transmission member 130c and the sixth drive transmission member 130f are in a full meshing engagement state with the teeth 112. At this time, the tooth crests of the third drive transmission member 130c and the sixth drive transmission member 130f are opposite the bottoms of the tooth grooves of the teeth 112. When the ratchet mechanism rotates in the +X direction as shown in FIG. 18, it will sequentially switch among three states, i.e., the state in which the third drive transmission member 130c and the sixth drive transmission member 130f are in full meshing engagement with the teeth 112, the state in which the second drive transmission member 130b and the fifth drive transmission member 130e are in full meshing engagement with the teeth 112, and the state in which the first drive transmission member 130a and the fourth drive transmission member 130d are in full meshing engagement with the teeth 112.

### II. Ratchet Wrench

The first part describes the ratchet mechanism of the present application. In this part, the application of the ratchet mechanism in a wrench will be described.

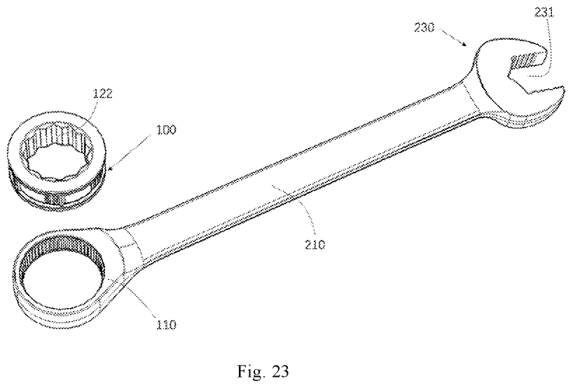

As shown in FIG. 22 and FIG. 23, a wrench 200 includes a handle 210, and an end thereof is provided with a corresponding wrench head 220. The wrench head 220 is provided with the ratchet mechanism 100 according to any one of Embodiments 1-2 therein. The first member 110 of the ratchet mechanism 100 may be configured to be integrally formed with the handle 210. In the shown example, the wrench head 200 is provided with a drive portion 122, and the drive portion 122 may cooperate with the outer sides of various nuts, screws, and the like. When a user operates the handle 210 and applies a torque to the handle 210, the first member 110 is driven to rotate. Through the drive transmission member 130, motion is transmitted to the second member 120, causing the drive portion 122 to rotate together, thereby achieving the purpose of outputting a torque. When the user rotates the handle 210 in an opposite direction, the ratchet mechanism 100 returns, while the second member 120 does not rotate, allowing the user's hand to reset and enabling continuous tightening or loosening of fasteners in confined spaces.

Another end of the handle 210 away from the ratchet mechanism 100 may further include a fixed wrench portion 230. A center of the fixed wrench portion 230 is provided with a third through hole 231, enabling the fixed wrench portion 230 to be fitted over external sides of external elements such as nuts. The third through hole 231 may be hexagonal, quadrilateral, or other structures capable of engaging external elements such as nuts, or may be any other structure capable of matching external elements such as nuts. A side wall of the third through hole 231 is provided with an opening to facilitate insertion of external elements such as nuts into the third through hole 231. Since the fixed wrench portion 230 has relatively greater strength compared to the ratchet mechanism 100, when a larger force is required to tighten or loosen external elements and the operating space is sufficient, the fixed wrench portion 230 may be used, offering more convenient operation and thereby broadening the application range of the wrench 200.

What are described above in detail are specific preferred embodiments of the present invention. It should be understood that those skilled in the art may make various modifications and changes based on the concept of the present invention without contributing any inventive labor. Therefore, any technical solution that can be obtained by those skilled in the art based on the concept of the present invention through logical analysis, reasoning, or limited experiments on the basis of the existing technology should also fall within the scope of protection defined by the claims.

1. A ratchet mechanism, wherein the ratchet mechanism comprises:
a first member having an annular surface, the annular surface being provided a plurality of teeth parallel to an axial direction thereof;
a second member rotatably disposed within the annular surface of the first member;
at least two pawl teeth, the at least two pawl teeth being disposed on at least one drive transmission member, the drive transmission member being movably disposed on the second member, the pawl teeth being configured to be capable of being in meshing engagement with the teeth to transmit motion between the first member and the second member, wherein the pawl teeth and the teeth have at least two different meshing engagement states.

2. The ratchet mechanism of claim 1, wherein the ratchet mechanism comprises a plurality of drive transmission members, and each of the plurality of drive transmission members has at least one pawl of the pawl teeth.

3. The ratchet mechanism of claim 2, wherein each of the plurality of drive transmission members is provided with at least two of the pawl teeth, wherein the meshing engagement states between the pawl teeth of each of the drive transmission members and the teeth have at least two types.

4. The ratchet mechanism of claim 3, wherein the pawl teeth of each of the drive transmission members are distributed sequentially along a sliding direction of the drive transmission member at which the pawl teeth are located, and a distance between a tooth crest of each pawl tooth and a tooth groove decreases sequentially, so that a contact area between the pawl teeth and the teeth decreases sequentially.

5. The ratchet mechanism of claim 1, wherein at least one accommodation cavity is disposed along a circumferential direction of the second member, one said drive transmission member is disposed within one said accommodation cavity, and the drive transmission member is configured to be slidable along the accommodation cavity, so that the pawl teeth extend out of an opening of the accommodation cavity.

6. The ratchet mechanism of claim 5, wherein each said drive transmission member is provided with a relief portion, and the relief portion is located on a side surface of the drive transmission member opposite to the pawl teeth.

7. The ratchet mechanism of claim 5, wherein a side of the accommodation cavity is provided with a first guide groove extending along a sliding direction of the drive transmission member, the drive transmission member has a first guide block cooperating with the first guide groove, and the first guide block is located within the first guide groove.

8. The ratchet mechanism of claim 5, wherein the ratchet mechanism comprises a cover, and the cover is fitted over an end face of the second member on which the accommodation cavity is provided.

9. The ratchet mechanism of claim 8, wherein the cover is provided with a positioning groove, and the second member is provided with a protrusion cooperating with the positioning groove.

10. The ratchet mechanism of claim 8, wherein the cover comprises a second guide groove extending along a sliding direction of the drive transmission member, the drive transmission member is provided with a second guide block cooperating with the second guide groove, and the second guide block is located within the second guide groove.

11. The ratchet mechanism of claim 1, wherein a width of the drive transmission member is equal to or greater than a dimension of the teeth along an axial direction of the first member.

12. The ratchet mechanism of claim 2, wherein the ratchet mechanism comprises at least two groups of drive transmission mechanisms, each group of drive transmission mechanisms comprises at least two drive transmission members, and meshing engagement states between the at least two drive transmission members and the teeth are same.

13. The ratchet mechanism of claim 12, wherein each group of the drive transmission mechanisms is symmetrically distributed along a circumferential direction of the second member.

14. The ratchet mechanism of claim 1, wherein the second member is provided with a drive portion, and the drive portion is configured to cooperate with an external element to transmit a torque to the external element.

15. The ratchet mechanism of claim 5, wherein an elastic member is disposed between the drive transmission member and the second member, the elastic member is configured to apply a force onto the drive transmission member, and the force urges the drive transmission member to move toward the teeth.

16. The ratchet mechanism of claim 15, wherein the elastic member is a spring, an end of the spring is sleeved over a boss of the drive transmission member, and another end of the spring is connected to a side wall of the accommodation cavity.

17. The ratchet mechanism of claim 16, wherein the side wall of the accommodation cavity is provided with a channel for receiving the spring.

18. The ratchet mechanism of claim 1, wherein the ratchet mechanism comprises a plurality of drive transmission members, the second member comprises a plurality of accommodation cavities, one of the drive transmission members is disposed within one of the accommodation cavities, each of the drive transmission members is provided with a plurality of pawl teeth, and an area between each of the pawl teeth and the teeth are different.

19. A wrench, wherein the wrench comprises a handle, and an end of the handle is provided with the ratchet mechanism of claim 1.

20. The wrench of claim 19, wherein the first member of the ratchet mechanism is integrally formed with the handle.
